(19) United States
(12) Patent Application Publication
(10) Pub. No.: US 2007/0038508 A1
(43) Pub. Date: Feb. 15, 2007

(54) Normalized click-through advertisement pricing

(75) Inventors: Kamal Jain, Bellevue, WA (US); Kunal Talwar, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/200,586

(22) Filed: Aug. 10, 2005

(51) Int. Cl. G06Q 30/00

(52) U.S. Cl. 705/14

(57) ABSTRACT

Normalized click-through advertisement pricing is described. Advertisements are assigned to advertisement slots on a web page. Click-through prices are calculated for each of the advertisements such that if a particular advertisement is selected by a user, an advertiser is charged the click-through price for that advertisement. Over time, the calculated click-through prices charged to the advertisers result in a normalized return on investment among the advertisements.

### BACKGROUND

Many companies spend a lot of money each year on advertisements. In traditional advertising environments (e.g., newspaper, magazines, television, etc.), the price of an advertisement is typically based on visibility. For example, an ad that is placed on the front page of a newspaper is typically more expensive than an ad that is placed on the third page of the second section of the newspaper. Similarly, an advertiser will pay more to have an ad broadcast on television during primetime than he would pay to have the same ad broadcast on television at 2:00 am. With these traditional methods of advertising, the cost of the advertisement is known up-front, and the expected return on investment is based on the degree of visibility that the advertisement receives.

Internet-based advertising differs somewhat in that advertisers are typically not charged for an ad being displayed, but are only charged if a user selects the ad, which typically directs the user to a website associated with the advertiser. This is commonly referred to as “click-through pricing”. Because advertisement visibility is still desired to attract a large number of users to the advertiser's website, high-visibility advertisement slots are desired. Advertisers typically bid auction-style for placement of ads within a web page, with the bid price indicating a maximum amount that the advertiser is willing to pay per click-through. For example, a search engine website may have five ad slots in a column down the right hand side of a web page on which search results are displayed. Advertisers may bid for those spots in conjunction with a particular keyword that a user may enter for a search. For example, a company that sells camera equipment may place a bid to have their advertisement displayed when a user submits a search using the keyword “camera”. When a user submits a search using the keyword “camera”, the ads from the advertisers who have submitted the five highest bids in association with the keyword “camera” are displayed in the five ad slots, with the ad from the highest bidding advertiser on top (i.e., in the most desirable of the five available ad slots).

Along with their bid, advertisers also submit a budget amount. After their budget is reached (based on the price paid per received click-through of the ad), the ad is no longer displayed. Over time, advertisers have realized that submitting lower bids can result in a higher return on investment than submitting higher bids. In other words, if an advertiser has a budget of $100, and bids 50 cents to win placement of the ad in the top slot on the web page, after 200 click-throughs, the advertiser's budget will be exceeded, and the ad will no longer be shown. On the other hand, if the advertiser bids only 10 cents to win placement of the ad in the fourth slot on the web page, then the advertiser will receive 1000 click-throughs before the budget is exceeded. As a result, advertisers are less willing to submit higher bids for ad placement, which results in lower revenue for companies that offer website ad placement.

### SUMMARY

Normalized click-through advertisement pricing is described. Advertisement-specific click-through prices are calculated for advertisements to be displayed via a particular web page. When a user selects on a particular advertisement, the click-through price associated with that advertisement is charged to an advertiser. The click-through prices may be equal across each of the advertisements, or may be calculated, for example, based on a measured attractiveness of each advertisement.

### BRIEF DESCRIPTION OF THE DRAWINGS

FIG. 1 is a pictorial diagram that illustrates an exemplary technique for normalizing click-through advertisement pricing.

FIG. 2 is a pictorial diagram that illustrates an exemplary technique for normalizing click-through advertisement pricing based, in part, on click-through rates associated with advertisements.

FIG. 3 is a pictorial diagram that illustrates an exemplary technique for normalizing click-through advertisement pricing based, in part, on expected click waits associated with advertisements.

FIG. 4 is a pictorial diagram that illustrates an exemplary technique for normalizing click-through advertisement pricing.

FIG. 5 is a block diagram that illustrates an exemplary network environment in which normalized click-through advertisement pricing may be implemented.

FIG. 6 is a flow diagram that illustrates an exemplary method for normalizing click-through advertisement pricing.

### DETAILED DESCRIPTION

The embodiments of normalized click-through advertisement pricing described below provide techniques for normalizing the expected return on investment associated with multiple ad slots on a single web page. Multiple ad slots on a web page have varying degrees of desirability to an advertiser. For example, if arranged as a vertical list the ad slot on top is typically most desirable because it is usually the first ad a user will see. Advertisers typically pay a particular amount (a click-through price) each time a user clicks on an ad. If higher click-through prices are charged for more desirable ad slots, advertisers may submit lower bids to increase their return on investment. With normalized prices for ads displayed on a web page, the cost associated with each click-through is the same (or approximately the same), regardless of ad placement. Because of this, the return on investment for each displayed ad is approximately equal. However, ad placement is typically determined as a function of the bids associated with each ad—ads with higher bids get placed in more desirable ad slots. Thus, advertisers have an incentive to bid higher in an attempt to win placement in the most desirable ad slot, which is expected to provide more click-throughs. The higher bids also result in more revenue for the ad slot provider.

The following discussion is directed to normalized click-through advertisement pricing. While features of normalized click-through advertisement pricing can be implemented in any number of different computing environments, they are described in the context of the following exemplary implementations.

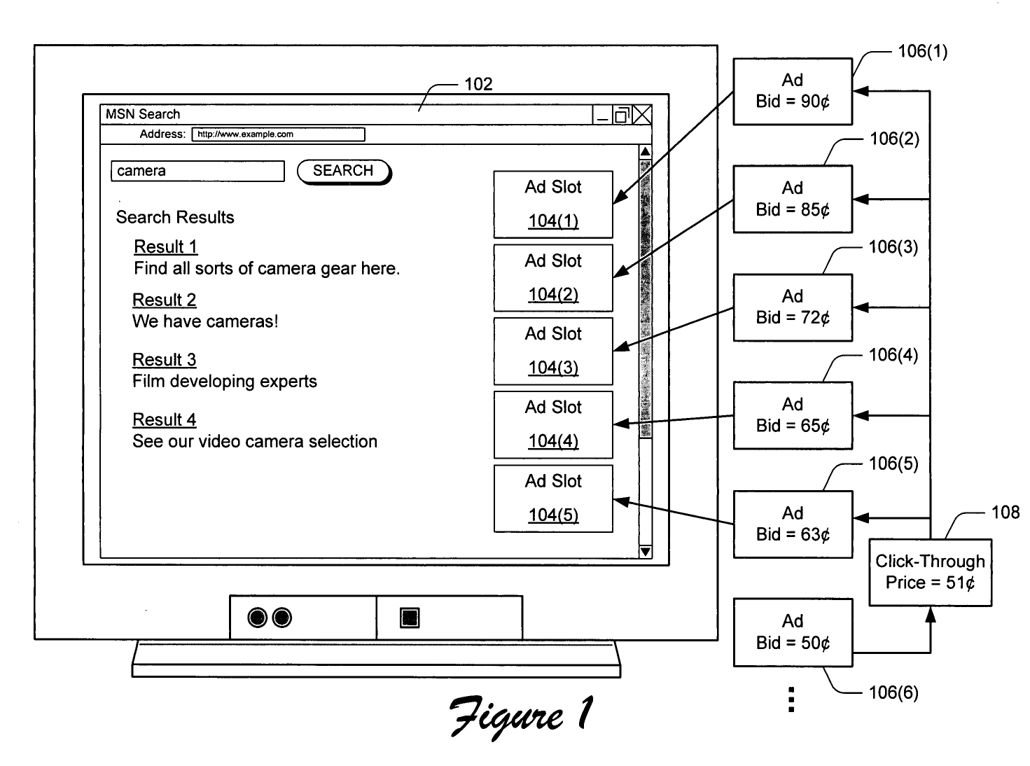

FIG. 1 illustrates an exemplary technique for normalizing click-through advertisement pricing. In an exemplary implementation, advertisers submit advertisements to an ad slot provider (e.g., a web page owner). The advertisements are then maintained by the ad slot provider such that the advertisements may be presented to a user via an ad slot at some future time. In addition to submitting an advertisement, an advertiser also submits a bid value and a budget value. The bid value indicates a maximum value that the advertiser is willing to pay if a user selects a particular ad (i.e., a click-through price). The budget value indicates a maximum value (calculated as a sum of charged click-through prices) that the advertiser is willing to pay for a particular advertisement over a fixed period of time (e.g., one day, one week, or one month). An advertisement is only available for display if a budget for the advertisement specified by the advertiser has not yet been reached.

In the illustrated example, web page 102 contains search results and five ad slots 104(1-5). It is assumed that ad slot 104(1) is more desirable than ad slot 104(2), which is more desirable than ad slot 104(3), and so on. When web page 102 is requested, five of the previously received advertisements are dynamically allocated to the available ad slots based on the previously received bids and budgets associated with the advertisements. Prior to displaying web page 102, advertisements 106(1), 106(2), 106(3), 106(4), 106(5), and 106(6) are identified as the previously received advertisement having the six highest bid values and sufficient remaining budget values (i.e., the click-through prices charged to the advertisers so far has not yet reached the specified budget values). The identified ads are sorted in descending order according to bid, as illustrated in FIG. 1. Ads 106(1-5) have the five highest bid values, and so, are the five winning advertisements that will be placed in the available ad slots. Ad 106(6) has the sixth highest bid, and so, is the first losing advertisement. Because ad 106(1) has the highest bid, it is assigned to the most desirable ad slot 104(1). Similarly, ad 106(2) is assigned to ad slot 104(2), and so on, with ad 106(5) being assigned to ad slot 104(5).

A click-through price 108 is calculated based on the bid associated with the first losing ad 106(6). In this example, one cent is added to the bid, resulting in a click-through price of 51 cents. This same click-through price 108 is then assigned to each of the winning ads 106(1-5), such that if a user viewing web page 102 clicks on any one of ads 106(1-5), the respective advertiser will be charged 51 cents.

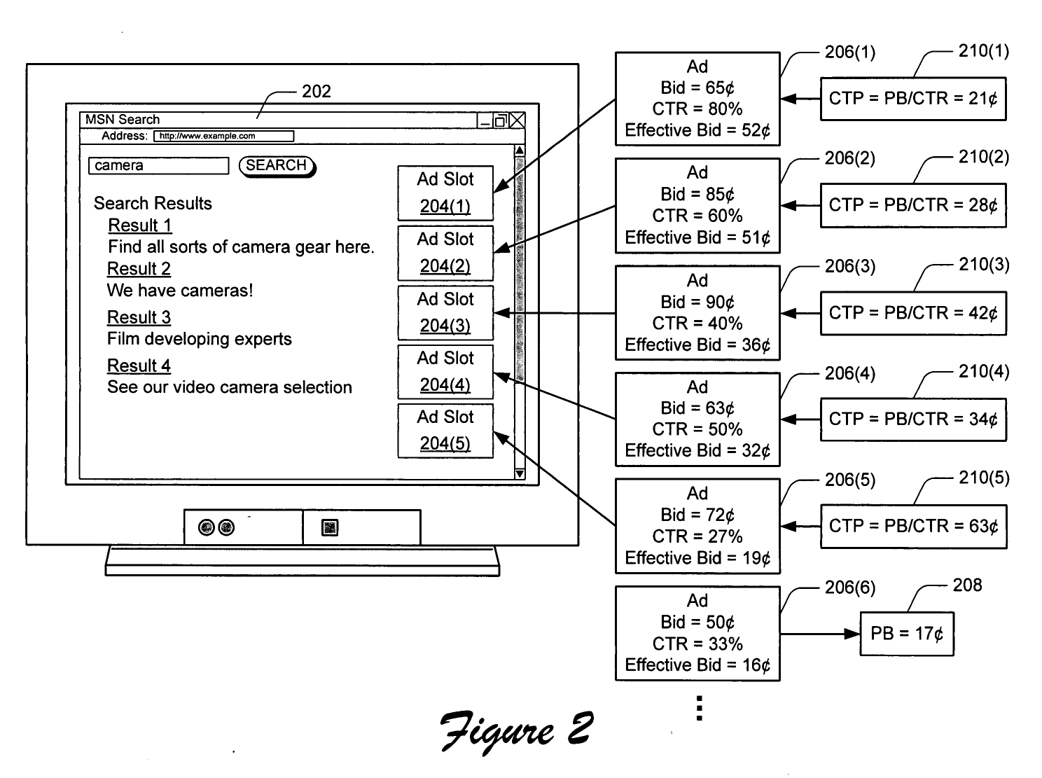

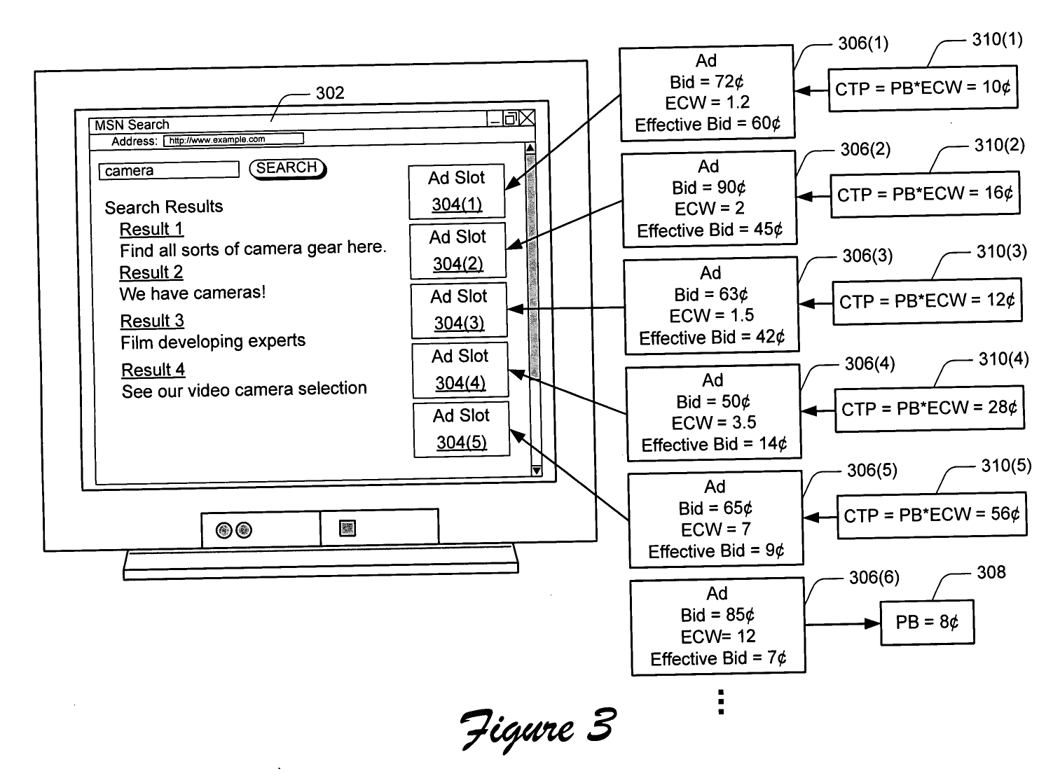

FIG. 1 illustrates a simplistic approach to assigning ads to ad slots and normalizing click-through prices based only on the received bid values. FIGS. 2 and 3 illustrate two alternative techniques for normalizing the click-through prices to be paid by the advertisers. It is recognized that any number of techniques may be used to assign ads to ad slots, and the examples shown herein are not to be construed as limitation for implementing normalized click-through pricing.

FIG. 2 illustrates an exemplary technique for normalizing click-through advertisement pricing based, in part, on click-through rates associated with the advertisements. In the illustrated example, web page 202 contains search results and five ad slots 204(1-5). It is assumed that ad slot 204(1) is more desirable than ad slot 204(2), which is more desirable than ad slot 204(3), and so on. Advertisements are dynamically allocated to the available ad slots each time the web page is generated.

As described above, previously received ads have an associated bid that indicates a maximum value that the advertiser is willing to pay each time a user clicks on the ad. In this example, each of the previously received ads also has an associated click-through rate (CTR) that indicates a frequency with which it is expected that a user will click on the ad. For example, a CTR of 80% indicates an expectation that a user will click on the ad 80% of the times that the ad is displayed. In an exemplary implementation, the CTR may be statistically determined by the web page (or an application associated with the web page). For example, when a new ad is received, a CTR of 50% may be assigned to the ad, indicating a 50-50 chance that a user will click on the ad when the ad is displayed. Over time, data is gathered each time the ad is displayed, indicating whether or not a user clicked on the ad. Based on this gathered data, the CTR associated with the ad is dynamically updated.

An effective bid is calculated for each of the previously received ads. The effective bid represents an expected income for the ad slot provider each time the ad is displayed based on the bid and the CTR. For example, if an ad has a bid value of 65 cents and a CTR of 80%, then 80% of the times that the ad is displayed, the ad slot provider can expect to receive 65 cents. Accordingly, on average, the ad slot provider can expect to receive approximately 52 cents (80% of 65 cents) each time the ad is displayed.

After calculating the effective bid values, the previously received ads are sorted in descending order according to the calculated effective bid. Ads 206(1-6) are identified, as illustrated in FIG. 2, as the ads having the six highest effective bids and a sufficient residual budget. Because ad 206(1) has the highest effective bid, it is assigned to the most desirable ad slot 204(1). Similarly, ad 206(2) is assigned to ad slot 204(2), and so on, with ad 206(5) being assigned to ad slot 204(5).

A pseudo bid (PB) 208 is calculated based on the effective bid associated with first losing ad 206(6). In this example, one cent is added to the effective bid associated with the first losing ad 206(6), resulting in a PB of 17 cents. The PB is then used to calculate normalized click-through prices (CTPs) for each of the five winning ads 206(1-5) assigned to the available ad slots. In the illustrated example, the CTP 210 for a particular ad is calculated by dividing the PB 208 by the CTR associated with the ad. For example, for ad 206(1), the CTP 210(1) is calculated as:
17 cents/80%=21 cents
Although each ad is not assigned the same click-through price, the advertisers are, on the average, paying approximately the same price per display of their respective ads. For example, for ad 206(1), each time a user clicks on the ad, the advertiser is charged 21 cents. According to the CTR for the ad, the ad is clicked 80% of the times that it is displayed. Accordingly, on average, the advertiser pays approximately 16.8 cents each time the ad is displayed. Similarly, for ad 206(3), each time a user clicks on the ad, the advertiser is charged 42 cents. According to the CTR for the ad, the ad is clicked only 40% of the times that it is displayed. Accordingly, on average, the advertiser pays approximately 16.8 cents each time the ad is displayed—the same amount paid by the advertiser associated with ad 206(1).

FIG. 3 illustrates an exemplary technique for normalizing click-through advertisement pricing based, in part, on expected click waits associated with the advertisements. In the illustrated example, web page 302 contains search results and five ad slots 304(1-5). It is assumed that ad slot 304(1) is more desirable than ad slot 304(2), which is more desirable than ad slot 304(3), and so on. Advertisements are dynamically allocated to the available ad slots each time the web page is generated.

As described above, previously received ads have an associated bid that indicates a maximum value that the advertiser is willing to pay each time a user clicks on the ad. In this example, each of the previously received ads also has an associated expected click wait (ECW) that indicates a number of times that the ad is expected to have to be displayed before a user will click on the ad. For example, an ECW of two indicates an expectation that a user will click on the ad, on average, every two times that the ad is displayed. In an exemplary implementation, the ECW may be statistically determined by the web page (or an application associated with the web page). For example, when a new ad is received, an ECW of two may be assigned to the ad, indicating a 50-50 chance that a user will click on the ad when the ad is displayed. Over time, data is gathered each time the ad is displayed, indicating whether or not a user clicked on the ad. Based on this gathered data, the ECW associated with the ad is dynamically updated.

An effective bid is calculated for each of the previously received ads. The effective bid represents an expected income for the ad slot provider each time the ad is displayed based on the bid and the ECW. For example, if an ad has a bid value of 72 cents and an ECW of 1.2, then every 1.2 times that this ad is displayed, the ad slot provider can expect to receive 72 cents. Accordingly, the ad slot provider can expect to receive approximately 60 cents (72 cents/1.20 displays) each time the ad is displayed.

After calculating the effective bid values, the previously received ads are sorted in descending order according to the calculated effective bid. Ads 306(1-6) are identified, as illustrated in FIG. 3, as the ads having the six highest effective bids and a sufficient residual budget. Because ad 306(1) has the highest effective bid, it is assigned to the most desirable ad slot 304(1). Similarly, ad 306(2) is assigned to ad slot 304(2), and so on, with ad 306(5) being assigned to ad slot 304(5).

A pseudo bid (PB) 308 is calculated based on the effective bid associated with first losing ad 306(6). In this example, one cent is added to the effective bid associated with the first losing ad 306(6), resulting in a PB of eight cents. The PB is then used to calculate normalized click-through prices (CTPs) for each of the five winning ads 306(1-5) assigned to the available ad slots. In the illustrated example, the CTP 310 for a particular ad is calculated by multiplying the PB 308 by the CTR 310 associated with the ad. For example, for ad 306(2), the CTP 310(2) is calculated as:
8 cents*2=16 cents
Although each ad is not assigned the same click-through price, the advertisers are, on the average, paying approximately the same price per display of their respective ads. For example, for ad 306(3), each time a user clicks on the ad, the advertiser is charged 12 cents. According to the ECW for the ad, the ad is clicked every 1.5 times that it is displayed. Accordingly, on average, the advertiser pays approximately 8 cents each time the ad is displayed. Similarly, for ad 306(4), each time a user clicks on the ad, the advertiser is charged 28 cents. According to the ECW for the ad, the ad is clicked every 3.5 times that it is displayed. Accordingly, on average, the advertiser pays approximately 8.0 cents each time the ad is displayed—the same amount paid by the advertiser associated with ad 306(3).

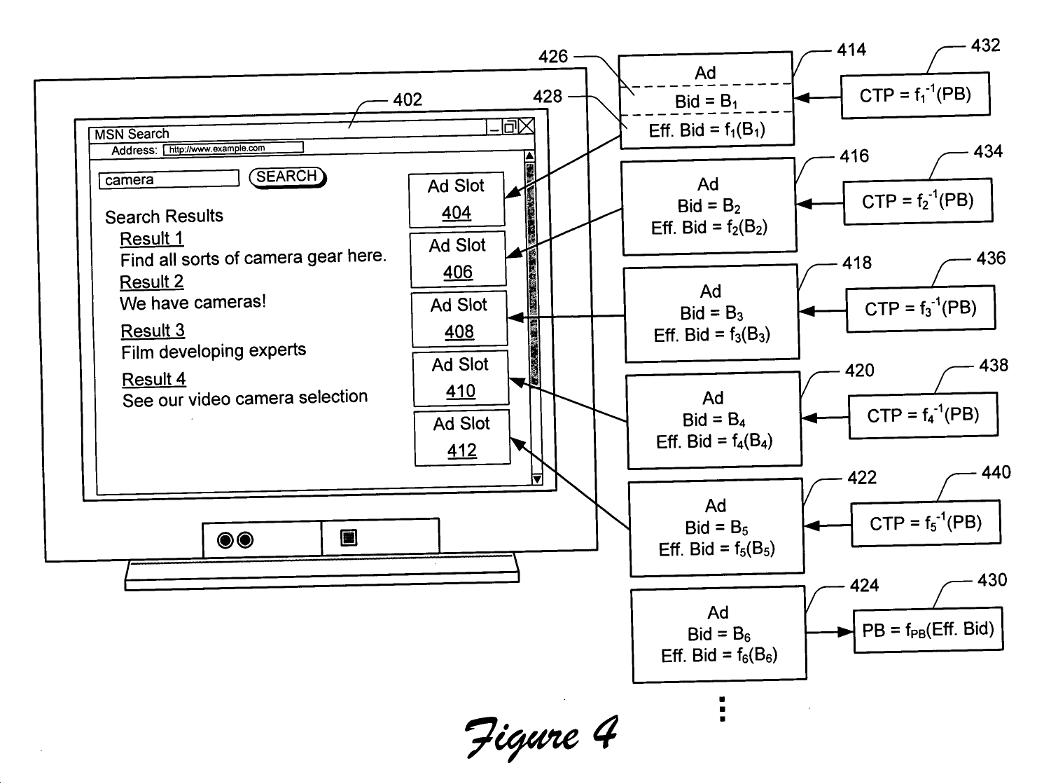

FIG. 4 illustrates an exemplary technique for normalizing click-through advertisement pricing. In the illustrated example, web page 402 contains search results and ad slots 404, 406, 408, 410, and 412. Advertisements are dynamically allocated to the available ad slots each time the web page is generated. Prior to displaying web page 402, previously received advertisements 414, 416, 418, 420, 422, and 424 are identified.

As described above, each previously received ad has an associated bid that indicates a maximum amount that the advertiser is willing to pay each time a user clicks on the ad. For example, bid 426 indicates a maximum value that an advertiser is willing to pay each time ad 414 is selected by a user. An effective bid is calculated for each ad according to some function fᵢ(Bᵢ) where Bᵢ is the bid associated with a particular ad. For example, effective bid 428 is calculated in association with advertisement 414. As illustrated in FIGS. 2 and 3, respectively, fᵢ(Bᵢ) may, for example, be based on a previously determined click-through rate (CTR) or expected click wait (ECW) associated with the particular ad. In an exemplary implementation, the effective bid represents an expected income for the ad slot provider each time the ad is displayed. The ads are then sorted in descending order based on the calculated effective bid. The first five ads (e.g., ads 414, 416, 418, 420, and 422) are identified as the winning ads with the five highest effective bids which will be assigned to the five available ad slots. Ad 424 is identified as the first losing ad.

A pseudo bid (PB) 430 is calculated according to some function f_{PB}(B_{X}) where Bx is the effective bid calculated with respect to the first losing ad (e.g., ad 424). In the examples shown in FIGS. 1-3, f_{PB}(B_{X})=B_{X}+0.01. In an exemplary implementation, a minimum pseudo bid may be enforced. In such an implementation, if the calculated PB is less than the minimum allowed value, then the PB is set to the minimum allowed value rather than the calculated value.

The PB is then used to calculate normalized click-through prices (CTPs) for each of the winning ads. In the illustrated example, the CTP for a particular ad is calculated by applying to the PB, the inverse of the function used to calculate the effective bid for the particular ad. For example, for ad 414, the effective bid 428 was calculated according to the function f₁(B₁), where B₁ was the bid 426 associated with ad 414. Accordingly, the CTP 432 for ad 414 is calculated as:
CTP=f₁⁻¹(PB)
For example, in the implementation illustrated in FIG. 1:
f₁(B₁)=B₁ and f₁⁻¹(PB)=PB
Similarly, in the implementation illustrated in FIG. 2:
f₁(B₁)=(B₁*CTR₁) and f₁⁻¹(PB)=(PB/CTR₁)
Finally, in the implementation illustrate in FIG. 3:
f₁(B₁)=(B₁/ECW₁) and f₁⁻¹(PB)=(PB*ECW₁)

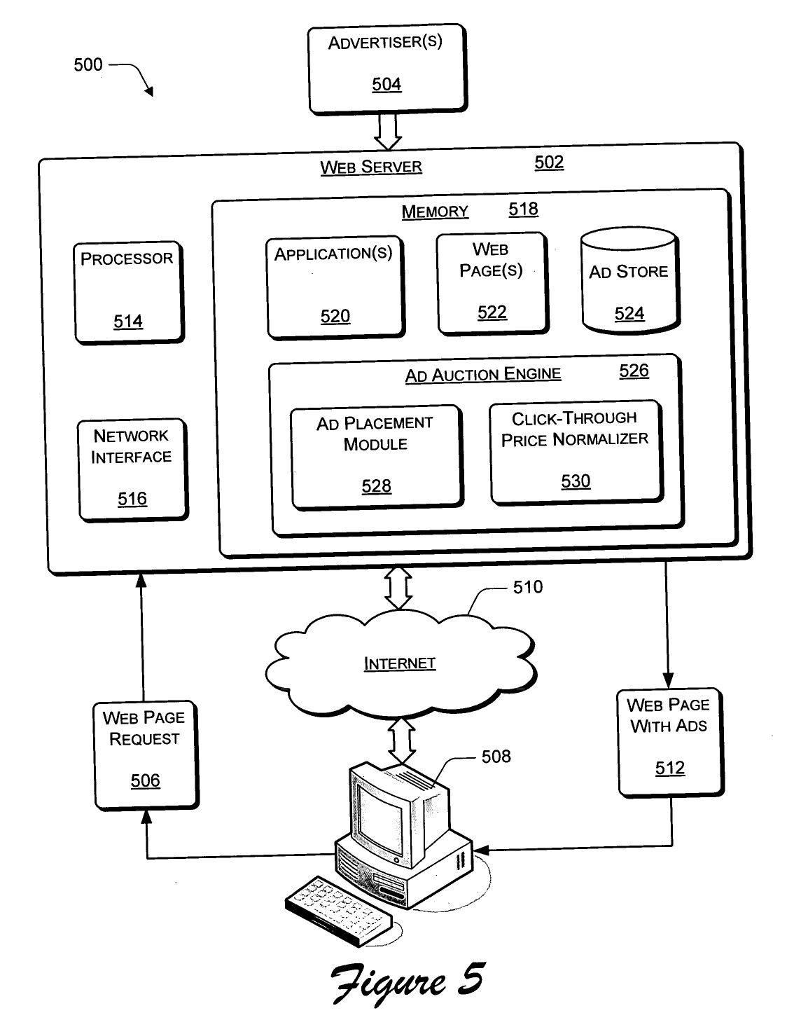

FIG. 5 illustrates an exemplary network environment 500 in which normalized click-through advertisement pricing may be implemented. A web server 502 hosts one or more web pages that may display advertisements. One or more advertisers 504 submit advertisements to web server 502. Each advertisement includes a bid that indicates a maximum price that the advertiser is willing to pay each time the advertisement is selected by a user when displayed on a web page. A web page request 506 may be submitted via computer system 508 to web server 502 via a network such as the Internet 510. Web server 502 dynamically inserts advertisements into the web page, and returns the requested web page with ads 512.

Selected components of web server 502 may include a processor 514, a network interface 516, and memory 518. Network interface 516 enables web server 502 to receive data from advertiser(s) 504, and to communicate with computer system 508 over the Internet 510. One or more applications 520, one or more web pages 522, ad store 524, and ad auction engine 526 are maintained in memory 518 and executed on processor 514.

Web pages 522 each include one or more ad slots via which advertisements received from advertisers 504 may be presented. In the described exemplary implementation, ad slots on a web page may have varying degrees of desirability that may be based, for example, on visibility. For example, if a web page has one ad slot at the top of the page and another ad slot at the bottom of the page, the ad slot at the top of the page would be expected to have higher visibility, and therefore would be more desirable to advertisers. The ad slots associated with a web page may be ordered according to their respective desirability.

Ad store 524 maintains data associated with advertisements received from advertisers 504. Data that may be maintained may include, but is not limited to, an advertisement, a bid, a budget, a click-through rate, and/or an expected click wait. As described above, the bid indicates a maximum value that the advertiser is willing to pay per click-through of the ad. The budget indicates a maximum value that the advertiser is willing to pay for placement of the ad over a particular period of time. For example, an advertiser may indicate a budget of $50 per day, or $1000 per month. The click-through rate may be determined by web server 502, and indicates an expected, or statistically determined, percentage that indicates a frequency with which the ad is expected to be selected by a user. For example, a click-through rate of 80% indicates that for every ten times that the ad is displayed, it is expected that a user will click on the ad eight times. Click-through rates are described in further detail above with reference to FIG. 2. Similarly, the expected click wait may also be determined by web server 502, and indicates a number of times that the ad is expected to be displayed before a user selects the ad. Expected click waits are described in further detail above with reference to FIG. 3.

Ad auction engine 526 includes ad placement module 528 and click-through price normalizer 530. Ad placement module 528 is configured to determine which ads in ad store 524 are to be presented via a particular web page 522. Ad placement module 528 also determines which of the identified ads are to be presented in each of the available ad slots. As described above with reference to FIGS. 1-4, any number of techniques may be used to determine placement of ads in the available ad slots. Click-through price normalizer 530 is configured to determine for each ad placed in an ad slot, a click-through price that is normalized in relation to the other ads placed in the other ad slots on the web page, such that the expected return on investment to an advertiser for each displayed ad is approximately equal. Example normalizing techniques have been described above with reference to FIGS. 1-4, and may include, but are not limited to, normalizing the click-through prices based on received bid, or normalizing the click-through prices based on a combination of received bid and ad attractiveness, as indicated by an expected click-through rate and/or an expected click wait associated with each ad.

Methods for normalized click-through advertisement pricing may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

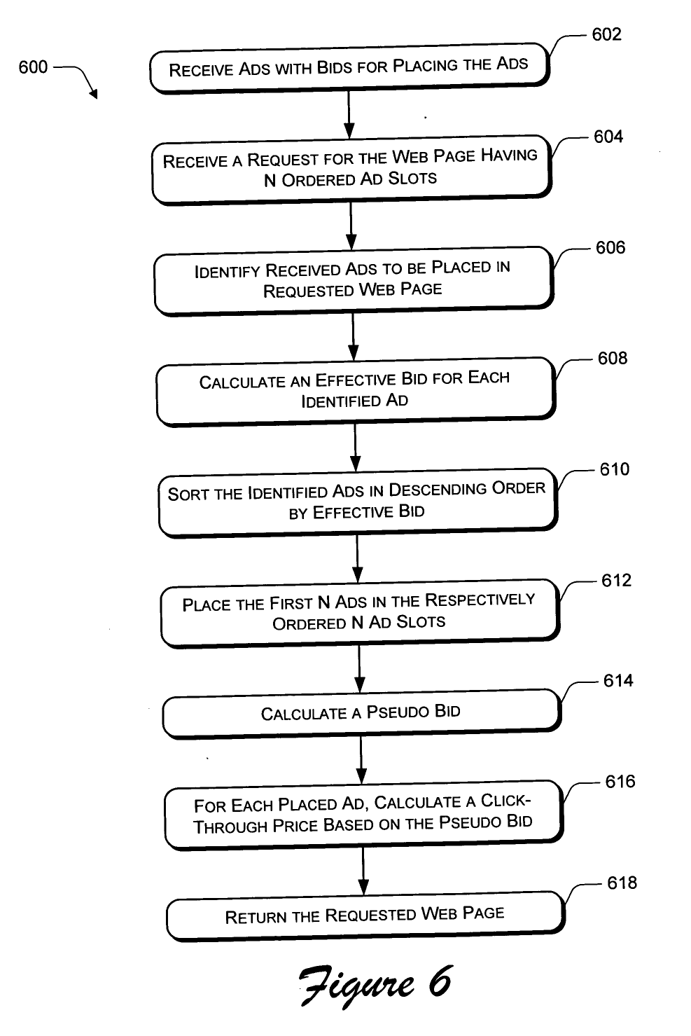

FIG. 6 illustrates an exemplary method 600 for normalizing click-through advertisement pricing. FIG. 6 is a specific example of normalized click-through advertisement pricing, and is not to be construed as a limitation. Furthermore, it is recognized that various embodiments may implement any combination of portions of the method illustrated in FIG. 6. The order in which the method is described is not intended to be construed as a limitation, and any number of the described method blocks can be combined in any order to implement the method. Furthermore, the method can be implemented in any suitable hardware, software, firmware, or combination thereof.

At block 602, ads with associated bids are received. Each bid indicates a maximum value that an advertiser is willing to pay each time the ad is selected by a user. For example, web server 502 may receive one or more advertisements and bids from advertiser(s) 504. The bids may also indicate one or more web pages in which the advertiser would like to have the ad placed.

At block 604, a request for a particular web page having N ordered ad slots is received. For example, web server 502 receives web page request 506 from computer system 508 via the Internet 510.

At block 606, one or more of the received ads are identified for possible placement in the requested web page. For example, ad auction engine queries ad store 524 to identify the received ads that may be placed in available ad slots on the requested web page. As one example, placement of a particular ad on a particular web page may be based on a keyword that was entered by a user as search criteria.

At block 608, an effective bid for each identified ad is calculated. Any number of techniques may be implemented for calculating the effective bids. For example, as illustrated in FIG. 1, the effective bid may be equal to the bid entered by the advertiser. As another example, as illustrated in FIGS. 2 and 3, a click-through rate or expected click wait value may be used in conjunction with the submitted bid value to calculate an effective bid.

At block 610 the identified ads are sorted in descending order by effective bid. At block 612, the first N sorted ads are placed in the respectively ordered N ad slots on the web page. For example, ad placement module 528 places the ad with the highest effective bid in the most desirable ad slot, the ad with the second highest effective bid in the second most desirable ad slot, and so on.

At block 614, a pseudo bid is calculated. For example, click-through price normalizer 530 may calculate a pseudo bid based on the effective bid associated with the (N+1)^{th} ad, as ordered by effective bid. An exemplary calculation of the pseudo bid increments the effective bid of the (N+1)^{th} ad by one cent. In an exemplary implementation, a minimum pseudo bid is also enforced such that if the calculated pseudo bid is less than the minimum pseudo bid, then the minimum pseudo bid is used.

At block 616, a click-through price is calculated for each placed ad based on the calculated (or minimum allowed) pseudo bid. For example, as illustrated in FIG. 4, for each placed ad, click-through price normalizer 530 may apply to the pseudo bid, an inverse of a function used to calculate the effective bid for the ad.

At block 618, the requested web page is returned. For example, web server 502 transmits the web page with ads 512 to computer system 508 over the Internet 510.

Although embodiments of normalized click-through advertisement pricing have been described in language specific to structural features and/or methods, it is to be understood that the subject of the appended claims is not necessarily limited to the specific features or methods described. Rather, the specific features and methods are disclosed as exemplary implementations of normalized click-through advertisement pricing.

1. A computer-implemented method comprising:
associating a first advertisement with a first ad slot;
associating a second advertisement with a second ad slot;
calculating first and second click-through prices to be respectively associated with the first and second advertisements such that when a user selects the first advertisement, the first click-through price is charged and when a user selects the second advertisement the second click through price is charged, wherein an expected return on investment for the first advertisement and an expected return on investment for the second advertisement are normalized.

2. The computer-implemented method as recited in claim 1, wherein the first click-through price is equal to the second click-through price.

3. The computer-implemented method as recited in claim 1, wherein calculating the first click-through price comprises:
determining a pseudo bid; and
calculating the first click-through price based on the pseudo bid.

4. The computer-implemented method as recited in claim 3, wherein determining the pseudo bid comprises determining a minimum allowed pseudo bid.

5. The computer-implemented method as recited in claim 3, wherein determining the pseudo bid comprises:
determining an effective bid associated with a third advertisement; and
calculating the pseudo bid based on the effective bid associated with the third advertisement.

6. The computer-implemented method as recited in claim 5, wherein determining the effective bid associated with a third advertisement comprises:
receiving a bid associated with the third advertisement; and
calculating the effective bid associated with the third advertisement based on the received bid associated with the third advertisement.

7. The computer-implemented method as recited in claim 6, wherein calculating the effective bid associated with the third advertisement comprises adding a pre-determined amount to the received bid associated with the third advertisement.

8. The computer-implemented method as recited in claim 6, wherein calculating the effective bid associated with the third advertisement comprises:
determining a click-through rate associated with the third advertisement wherein the click-through rate indicates a frequency with which it is expected that a user will select the third advertisement; and
multiplying the received bid associated with the third advertisement by the click-through rate associated with the third advertisement.

9. The computer-implemented method as recited in claim 6, wherein calculating the effective bid associated with the third advertisement comprises:
determining an expected click wait associated with the third advertisement wherein the expected click wait indicates a number of times that the third advertisement is expected to be displayed before a user will select the third advertisement; and
dividing the received bid associated with the third advertisement by the expected click wait associated with the third advertisement.

10. A system comprising:
a processor;
memory;
an ad auction engine maintained in the memory and executed on the processor, wherein the ad auction engine is configured to normalize click-through prices associated with advertisements presented via a web page.

11. The system as recited in claim 10, wherein the ad auction engine comprises:
an ad placement module configured to place advertisements in ad slots in the web page, such that a first advertisement with a highest effective bid is placed in a most desirable ad slot, and a second advertisement with a second highest effective bid is place in a second most desirable ad slot;
a click-through price normalizer configured to calculate first and second normalized click-through prices to be charged, respectively, if a user selects the first or second advertisement, such that over time, it is expected that an average price per-display charged for each of the first and second advertisements will be approximately the same, wherein the average price per display for the first advertisement is calculated as a sum of charged click-through prices for the first advertisement divided by a number of times the first advertisement was presented via an ad slot in the web page.

12. One or more computer-readable media comprising computer-readable instructions which, when executed, cause a computer system to:
receive an advertisement to be placed in a web page;
receive a bid indicating a maximum amount that an advertiser is willing to pay if the advertisement is selected by a user via the web page;
receive a request for the web page;
calculate an effective bid based, at least in part, on the received bid associated with the advertisement;
place the advertisement in an ad slot on the web page;
calculate a pseudo bid;
calculate a click-through price for the advertisement based, at least in part, on the pseudo bid;
associate the calculated click-through price with the advertisement; and
return the requested web page.

13. The one or more computer-readable media as recited in claim 12, wherein the effective bid is equal to the received bid associated with the advertisement.

14. The one or more computer-readable media as recited in claim 12, further comprising computer-readable instructions which, when executed, cause the computer system to calculate the effective bid based, at least in part, on an attractiveness of the advertisement.

15. The one or more computer-readable media as recited in claim 14, wherein the attractiveness of the advertisement is represented by a click-through rate that indicates a frequency with which it is expected that a user will select the advertisement.

16. The one or more computer-readable media as recited in claim 14, wherein the attractiveness of the advertisement is represented by an expected click wait that indicates a number of times that the ad is expected to be displayed before a user will select the ad.

17. The one or more computer-readable media as recited in claim 12, further comprising computer-readable instructions which, when executed, cause the computer system to:
calculate the effective bid by applying a function f(x) to the bid that was received; and
calculate the click-through price by applying an inverse function f¹(x) of the function f(x) to the pseudo bid.

18. The one or more computer-readable media as recited in claim 12, further comprising computer-readable instructions which, when executed, cause the computer system to calculate the pseudo bid based on a bid received in association with another advertisement.

19. The one or more computer-readable media as recited in claim 18, further comprising computer-readable instructions which, when executed, cause the computer system to calculate the pseudo bid by increasing the bid received in association with the another advertisement by a pre-determined amount.

20. The one or more computer-readable media as recited in claim 12, further comprising computer-readable instructions which, when executed, cause the computer system to calculate the pseudo bid by determining a minimum allowable pseudo bid value.
